(19) United States
(12) Patent Application Publication
(10) Pub. No.: US 2021/0107519 A1
(43) Pub. Date: Apr. 15, 2021

(54) RECONFIGURATION OF A VEHICLE BASED ON MONITORED USER BEHAVIOR

(71) Applicants: Bernd Gassmann, Straubenhardt (DE); Cornelius Buerkle, Karlsruhe (DE); Kay-Ulrich Scholl, Malsch (DE); Fabian Oboril, Karlsruhe (DE)

(72) Inventors: Bernd Gassmann, Straubenhardt (DE); Cornelius Buerkle, Karlsruhe (DE); Kay-Ulrich Scholl, Malsch (DE); Fabian Oboril, Karlsruhe (DE)

(21) Appl. No.: 17/131,569

(22) Filed: Dec. 22, 2020

(51) Int. Cl. B60W 60/00; G06N 5/04; G01C 21/34; G07C 5/08; B60W 40/08; B60W 50/00; B60W 50/14

(52) U.S. Cl. CPC B60W 60/0013; G06N 5/04; G01C 21/3407; B60W 2556/10; B60W 40/08; B60W 50/0097; B60W 50/14; G07C 5/0808

(57) ABSTRACT

Disclosed embodiments provide a mobility as a service (MaaS) platform that orchestrates a variety of services that require a variety of different vehicle configurations. To ensure a cost effective vehicle fleet, the disclosed MaaS platform dynamically reconfigures vehicles as needed to perform services that are in demand. To accomplish this, some embodiments provide an API that allows third party service providers to register with the MaaS platform. The registration indicates capabilities of the third party service providers, and service center locations. The API also allows the MaaS platform to obtain status information on the third party service providers to, for example, determine wait times of the third party service providers to assist with scheduling vehicles for conversion.

### BACKGROUND

A rise in Mobility-as-a-Service (MaaS) applications is expected over the coming years. MaaS providers will likely rely on a fleet of vehicles, and potentially a fleet of autonomous vehicles. To leverage the large investment in these vehicle fleets, the vehicles will be employed to accomplish a relatively large variety of different transportation services. Thus, solutions that ensure the vehicle fleet can successfully accomplish a variety of tasks are needed.

### BRIEF DESCRIPTION OF THE DRAWINGS

The present disclosure is illustrated by way of example and not limitation in the figures of the accompanying drawings, in which like references indicate similar elements and in which:

FIG. 1 is an overview diagram illustrating an example execution flow of a booking in one or more of the disclosed embodiments.

FIG. 2 is a conceptual diagram illustrating how a MaaS platform predicts needs of a user and provides them in advance.

FIG. 3 is an overview diagram illustrating communication between a 3rd party service and a MaaS platform

FIG. 4 shows example data structures implemented in one or more of the disclosed embodiments.

FIG. 5 is an overview diagram showing operation of a MaaS platform in one or more of the disclosed embodiments.

FIG. 6 is a block diagram showing an example organization of a MaaS platform.

FIG. 7 shows an example machine learning module according to some examples of the present disclosure.

FIG. 8 shows an example data flow implemented in one or more of the disclosed embodiments.

FIG. 9 is a flowchart of an example method of instructing a vehicle that is implemented in one or more of the disclosed embodiments.

FIG. 10 illustrates a block diagram of an example machine upon which any one or more of the techniques (e.g., methodologies) discussed herein may perform.

### DETAILED DESCRIPTION

As discussed above, ensuring a MaaS vehicle fleet meets the needs of a relatively larger variety of mobility services is an important factor to the success of said fleet. As one example, a vehicle configuration appropriate for transporting adults to a workplace differs, in some embodiments, from a vehicle configuration appropriate for transporting children to a sport oriented event, such as basketball training. While this is a simple example, a large variety of vehicle configurations are necessary to ensure a vehicle fleet that can perform a variety of mobility of a service tasks so as to ensure the fleet is competitive in a global marketplace for MaaS applications.

The disclosed embodiments recognize that providing this large variety of configurations via statically configured vehicles would impose too large of a cost on MaaS providers. Thus, the disclosed embodiments propose to provide for a dynamic reconfiguration of vehicles as needed to match vehicle configurations with MaaS demands, as those demands vary throughout different periods of time. To that end, the disclosed embodiments contemplate the use of vehicle service centers that reconfigure fleet vehicles as needed to meet present or predicted demand for different vehicle configurations.

To provide MaaS services under the above conditions, the disclosed embodiments propose a technical solution that includes a MaaS computer system platform configured to provide interfaces to third party service providers. These third party service providers can register with the MaaS platform to indicate their ability to provide vehicle configuration services. These interfaces allow 3^{rd} party entities and the fleet operator to electronically interface to determine services provided by the third party, expected turnaround time for vehicle reconfiguration, whether adequate parts are in stock to perform particular vehicle reconfigurations, or other information. The APT also allows the MaaS platform to assign particular vehicles to particular service providers, and obtain status information regarding the service providers, such as a number of configuration changes the service provider can support, wait times, and other information.

In some embodiments, a portion of the dynamic reconfiguration of a vehicle is performed by the fleet operator itself, while other types of dynamic reconfiguration of a vehicle are performed by a 3^{rd} party, which is orchestrated by the API. The third party is electronically interfaced with the disclosed fleet management system to ensure the vehicle reconfigurations provided by the fleet operator are as seamlessly provided to the end user as reconfigurations performed by the fleet operator. By providing this third party interface, the MaaS platform manages the complex operational task of scheduling vehicles, ensuring the vehicles are properly configured to perform their respective services, all while making this complexity seamless to users of the MaaS platform.

Some embodiments of this MaaS platform include an intelligent booking system that maintains user profiles. In some embodiments, the intelligent booking system automatically learns expected demand for services and their required vehicle configurations, along with user preferences for these services. The predictions of demand and service types by the intelligent booking system allow the MaaS platform to prepare, in advance, vehicle configurations necessary to satisfy the anticipated needs of MaaS customers. Because the intelligent booking system is able to predict demand for a variety of different MaaS services, the intelligent booking system can prepare the appropriate vehicle configurations in advance of the demand for their services, again contributing to the overall seamlessness of the service, and providing for a more efficient and therefore cost effective fleet operation.

The disclosed fleet management system also provides instructions to fleet vehicles to accomplish both the necessary reconfigurations and performance of MaaS functions. In the case of human operated vehicles, the instructions are provided in human readable form, such as via text based instructions that appear on a display screen of the vehicle. In the case of autonomous vehicles, the instructions are provided electronically to an in-vehicle control system, which electronically controls the vehicle and is capable of navigating the vehicle both to a service center as needed for reconfiguration, and to other locations necessary to provide services with the appropriate configuration.

At least some of the disclosed embodiments learn from individual user profiles and individual use cases how to combine available services and direct reconfiguration of vehicles as needed. High configurability and high availability is achieved via reconfiguration centers, live status reports by service providing entities, consideration of live traffic and on-the-fly re-planning. Some embodiments combine one or more of service, transportation, logistics, or food delivery tasks, which provides an improved user-experience and increasing advantages associated with utilization of mobility as a service provider when compared to owning a private vehicle.

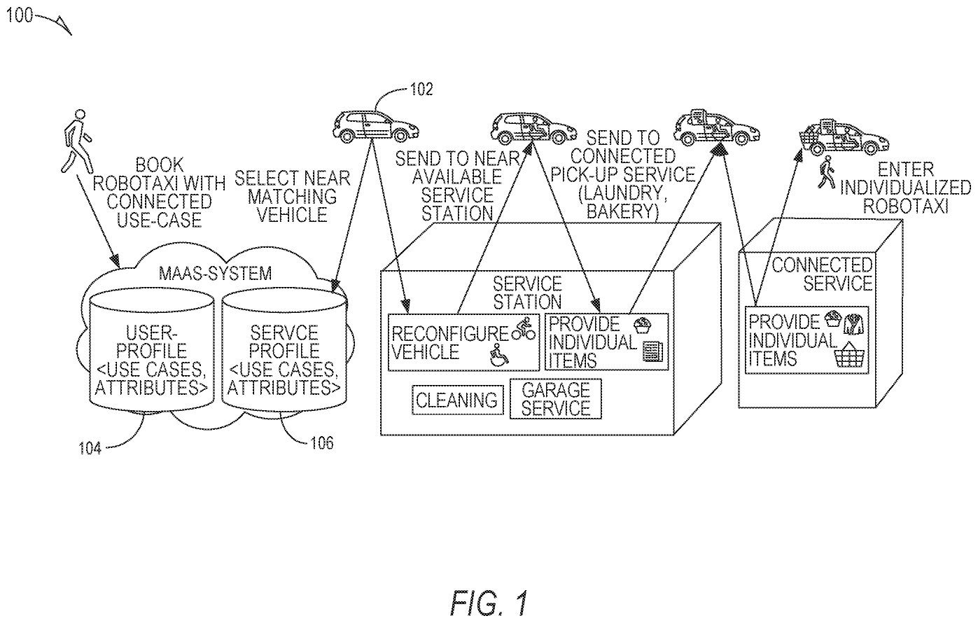

FIG. 1 is an overview diagram illustrating an example execution flow 100 of a booking in one or more of the disclosed embodiments. At least some of the disclosed embodiments reconfigure a vehicle 102 for a variety of different purposes, including, but not limited to, reconfiguration of seating to accommodate different levels of passenger mobility, loading a vehicle with passenger preferred items (e.g. favorite drinks, food, magazines, newspapers, setting air conditioning settings or seat positions), or configuring the vehicle to interface with passenger preferred third party service providers (e.g. drive through connected supermarket service for automated loading of goods into a storage area of the vehicle). A configuration or reconfiguration of a vehicle can include almost any physical modification to a vehicle, including changes that do not change the vehicle itself, but change the environment in which a passenger experiences the vehicle. Therefore, for example, configuring the vehicle can include tuning the radio to a particular radio station, or selecting a particular streaming application to play within the vehicle, Configuring the vehicle includes, in some embodiments, placing particular objects in the vehicle for passenger use or consumption. Thus, configuring the vehicle is not limited to changes to the vehicle itself.

Some of the disclosed embodiments collect and store user profile information 104 regarding each passenger/user that engages with the MaaS system. This information includes, for example, in some embodiments, one or more of an average and/or median party size of trips taken by the user, age, weight, or other characteristics of the passenger/user, any special needs of the passenger/user (e.g. wheelchair requirement, higher headroom for taller individuals), typical luggage or accessories carried by the passenger/user, service purposes, frequency of service occurrences, recurrence intervals, vehicle preferences (e.g. manufacturer, color), special needs of the passenger (child seat, whether extra headroom is preferred, special equipment needs, etc). Some of the disclosed embodiments include user profile information 104 indicating a type and amount of luggage typically carried by the user/passenger. In some embodiments, the luggage information stored in a user profile is destination specific. Thus, for example, in some embodiments, a trip taken to an airport invokes a first set of luggage characteristics while a second trip taken to a restaurant invokes a second set of luggage characteristics of the user.

The user profiles include, in some embodiments, vehicle preferences of a passenger/user. For example, preferences for a type of vehicle (Truck, Minivan, sedan) are collected via a user interface or derived (e.g. based on feedback scores). Some embodiments collect or derive vehicle color preferences in a similar manner and store this preference information in the user profile information 104.

The user profiles further include, in some embodiments, a preferred vehicle configuration. For example, some vehicle fleet operators define a plurality of vehicle configurations (e.g. an office configuration, a personal leisure configuration, or a party configuration). Some embodiments maintain user preferences relating to the types of services the user/passenger finds valuable. For example, a preferred laundry service, supermarket/shopping provider, breakfast provider, or coffee provider).

Some user profiles indicate whether particular services should be automatically booked at certain predicted times or if those services are manually booked, Some embodiments indicate, via the user profile information 104, additional vehicles that accompany the user/passenger on particular services. For example, some user profiles indicate whether an e-scooter or bike is brought with the user (e.g., for use during last mile of a trip, etc). Some other embodiments associate bookings of other services with particular service profiles. For example, some embodiments provide for automatic booking of an e-scooter reservation when a passenger books a vehicle service to a college campus.

Some embodiments determine service profiles 106 based on a repeated use of MaaS services having common characteristics. The service profiles 106 indicate a recurrence time period for one or more types of services. Based on an analysis of previous user behavior and use of MaaS services, some of the disclosed embodiments determine, for example, that a first type of service occurs weekday mornings (e.g. driving children to school or traveling to a work place), and a second type of service occurs every second Sunday of a month (attending a cars and coffee event). In some embodiments, the service profiles 106 indicate common intermediate stopping points. For example, some embodiments identify stopping points at a preferred roadhouse during trips longer than a threshold distance, or a stopping point at a family members house during a daily or weekly trip within the vicinity of said family member's house.

Some of the disclosed embodiments provide the above user and service profile information to a machine learning model to provide for predictions of user preferences and thus improve the user's future travel experience. Use of these techniques reduce an amount of information the user needs to manually provide to facilitate use of the mobility as a service platform. For example, the MaaS platform makes suggestions for services, stopping points, and user preferences that can simply be confirmed by the user.

As part of providing a mobility service, the disclosed MaaS platform compares incoming service requests, vehicles, and vehicle configurations needed against available vehicles and configurations. If a vehicle having the appropriate configuration is available to fulfill a particular request, the vehicle is assigned to the request, at least in some embodiments. The identified vehicle is instructed, in some embodiments, to proceed to a location associated with the request (e.g. a pick-up location for a passenger). If no vehicle is available with an appropriate configuration, to satisfy a request, a vehicle is selected for reconfiguration and instructed to travel to a service center to be so configured. In some cases, the vehicle is instructed with sufficient advance notice such that vehicle reconfiguration is complete before performance of the requested service is needed.

In some other cases, if a vehicle having the configuration is not available, the user is offered a choice between accepting an available vehicle, with an associated availability time, or waiting for a vehicle to be reconfigured to meet their specific requirements. In some embodiments, a cost differential between the two options is also presented to the user. For example, the user is offered a discounted price, in some embodiments, to accept an available vehicle, which is likely also lower cost to the fleet operator.

Some embodiments differentiate between a time requirement or resource requirement of a reconfigurations. For example, a first class of reconfiguration requires a first amount of elapsed time to complete and/or imposes a first cost on a fleet operator, while a second class of reconfiguration requires a second amount of elapsed time to complete and/or imposes a second cost on the fleet operator.

Some embodiments periodically reevaluate an assignment of a vehicle to a service request, and change the assignment under certain conditions. For example, if a first vehicle assigned to a first service request ends up delayed due to traffic along its route, some of the disclosed embodiments recognize that an arrival time of the first vehicle is not competitive with a projected arrival time of a second vehicle. As a result, some of the disclosed embodiments reassign the service request to the second vehicle.

As some MasS services include autonomous delivery of valuable items, some embodiments include lockable containers to secure goods during transportation. In some cases, these lockable containers are transferrable from a first vehicle to a second vehicle, while maintaining security of any contents held within.

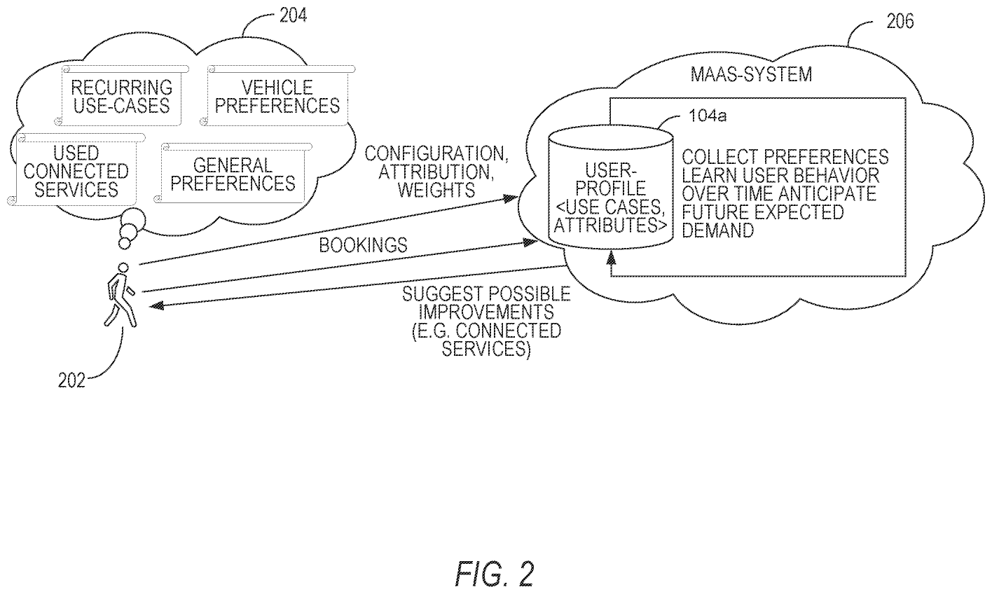

FIG. 2 is a conceptual diagram illustrating how a MaaS platform predicts needs of a user and provides them in advance. FIG. 2 shows a user 202. The user has thoughts of particular preferences of the user 204. FIG. 2 shows how a MaaS platform 206 captures and stores these preferences as a user profile 104a. Based on knowledge of the user's preferences gained by the stored user profile 104a, the MaaS platform 206 is able to suggest possible improvements to the user 202. For example, the MaaS platform 206 can suggest ways the user 202 can improve their use of connected services via the MaaS platform 206.

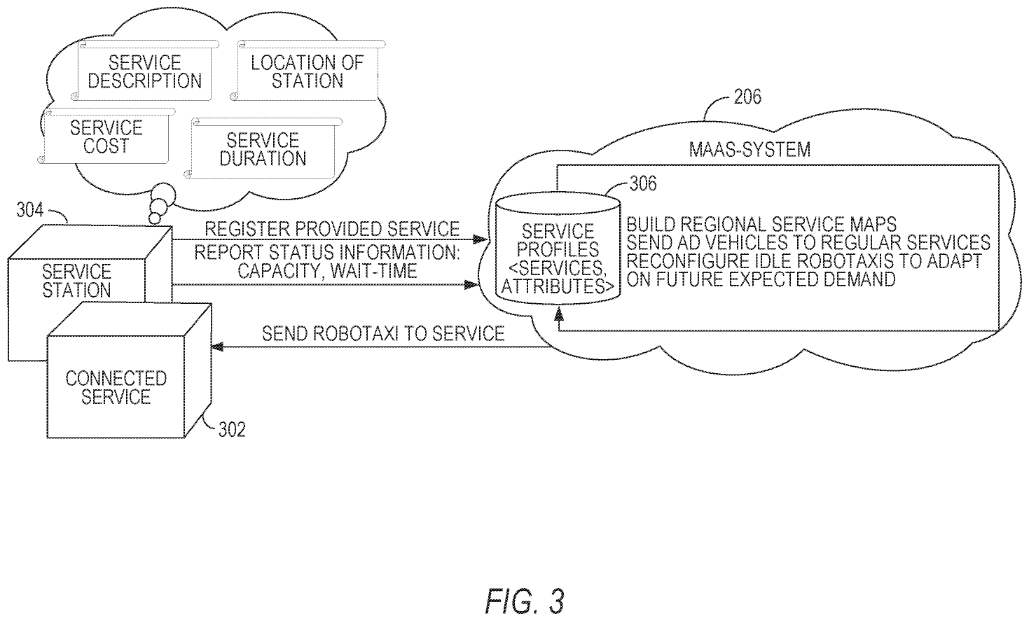

FIG. 3 is an overview diagram illustrating communication between a 3rd party service and a MaaS platform. As discussed above, at least some embodiments of the proposed MaaS platform publish APIs that allow electronic interfacing with 3rd party service providers. FIG. 3 shows a connected service 302 provided by a third party. The third party also maintains a service station or service center 304.

Via a provided API, the 3^{rd} party service provider configures, in some embodiments, a service profile 306 and maintains profile information indicating its capabilities, available capacities, and expected wait/service times. Some service providers automate their respective sides of the API interface, and/or provide platforms that automate the providing of their respective services (e.g. vehicle cleaning and/or reconfiguration). Some service providers delivery their services manually (e.g. placing passenger preferred articles in a vehicle, etc).

Via APIs published by the MaaS platform 206, the 3^{rd} party service provider is able to indicate a type of one or more services provided. Services provided include, in various embodiments, one or more of vehicle cleaning, vehicle provisioning with food/drink choices, changing of seating configuration, fuel/charge replenishment, or other services). Via the API, the service provider also indicates, in some embodiments, a type of vehicle the 3rd party provider is capable of reconfiguring and/or status information. Status information communicated via the API includes, in some embodiments, one or more of a current ability to accept new service requests, a projected service capacity over a prospective time period, an expected wait time for service to be provided. The API also offers, in some embodiments, an ability of the MaaS platform 206 to reserve or schedule a service appointment. Some embodiments provide for a service provider to receive a list of one or more linked services. The linked services are initiated by the 3rd party service provider after completing a particular service on a vehicle.

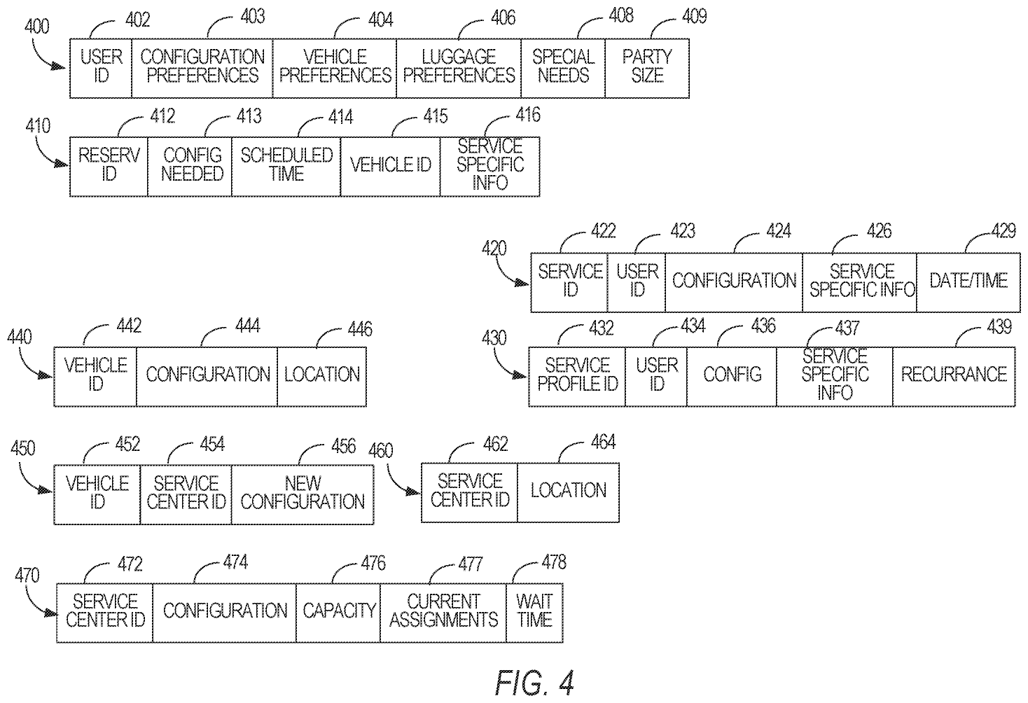

FIG. 4 shows example data structures implemented in one or more of the disclosed embodiments. Although the example data structures of FIG. 4 are illustrated and discussed as relational database tables, the disclosed embodiments are not limited to this particular data architecture and a variety of different data structures are contemplated. For example, various embodiments utilize linked lists, arrays, unstructured data stores, or other data architectures to implement the disclosed features and functions.

FIG. 4 shows a user account table 400, reservations table 410, service table 420, service profile table 430, vehicle table 440, vehicle reconfiguration table 450, service center table 460, and a service center capabilities table 470.

The user account table 400 includes a user identifier field 402, configuration preferences field 403, vehicle preferences field 404, and a luggage preferences field 406, a special needs field 408, and a party size field 409. The user identifier field 402 uniquely identifies a particular user, user account, or passenger. The configuration preferences field 403 indicates particular configuration preferences of the user (identified by the user identifier field 402). For example, the configuration preferences field 403 indicates in some embodiments, drink, food, entertainment, digital connectivity, or reading material preferences of the user to be included in the vehicle. The party size field 409 indicates a typical party size that accompanies the user during a mobility service.

The vehicle preferences field 404 indicate vehicle preferences of the user, such as make, model, color, or other preferences relating to the vehicle itself. The vehicle preferences field 404 indicates, in some embodiments, whether the user prefers a vehicle configuration that includes a child seat, a sunroof, or a rear facing seat. The luggage preferences field 406 indicates a luggage or other accessories typically carried by the passenger/user identified by the user identifier field 402. The special needs field 408 indicates special needs of the user/passenger. For example, if the passenger requires a wheelchair, crutches, special drop off accommodations, a support animal, or other special accommodations, they can be indicated in the special needs field 408.

The reservations table 410 includes a reservation identifier field 412, configuration needed field 413, scheduled time field 414, a vehicle identifier field 415, and a service specific information field 416. The reservation identifier field 412 uniquely identifies a particular reservation for a particular service at a particular time. The configuration needed field 413 indicates a vehicle configuration needed to complete the reservation. The scheduled time field 414 indicates the time of the reservation. The vehicle identifier field 415 indicates a vehicle assigned to the reservation. The service specific information field 416 indicates information specific to the particular service provided. For example, for a transportation service, the service specific information field 416 indicates, in some embodiments, an origin and/or destination of the trip.

The service table 420 includes a service identifier field 422, user identifier field 423, configuration field 424, service specific information field 426, and a date/time field 129, The service table 420 records historical services by users of a MaaS platform. The service identifier field 422 uniquely identifies a particular service. The user identifier field 423 uniquely identifies a user/passenger/account participating in the service. The configuration field 424 identifies a vehicle configuration used for the service. The service specific information field 426 stores information specific to a service provided. For example, if the service is a transportation service, in some embodiments, the service specific information field 426 indicates an origin and destination of a trip. The date/time field 429 identifies a date and time the service occurred.

The service profile table 430 includes a service group identifier field 432, user identifier field 434, configuration field 436, service specific information field 437, and a recurrence field 439. The service profile table 430 identifies recurring service patterns from the service table 420. The service group identifier field 432 identifies a unique recurring service pattern identified by one or more of the disclosed embodiments. The user identifier field 423 identifies a user exhibiting the identified recurring service pattern. The service specific information field 437 stores information relating to the specific service provided. For example, if the service is a transportation service, the service specific information field 437 stores, in some embodiments, an origin and destination of the recurring service pattern. In some embodiments, the service specific information field 437 indicates a geographic region from which the recurring service pattern generally originates (e.g. not necessarily a specific point, e.g. a region ½ km×½ km, or larger, or smaller). The service specific information field 437 also stores, in some embodiments, a destination location of the recurring service pattern. As with the origin, the destination identifies, in some embodiments, a region encompassing a geographic area that is larger than a simple single location (e.g. a region ½ km by ½ km, or larger, or smaller). The recurrence field 439 defines a recurrence of the identified service group or service pattern. Thus, the recurrence field 439 indicates, in some embodiments, whether the service group/service pattern recurs, on weekdays, Saturdays, the second Tuesday of every month, once per year, or other recurrence pattern.

The vehicle table 440 includes a vehicle identifier field 442, configuration field 444, and a location field 446. The vehicle identifier field 442 uniquely identifies a vehicle. The configuration field 444 identifies a current or present configuration of the vehicle (identified by the vehicle identifier field 442). The configuration field 444 is consulted, by some embodiments, when determining whether the vehicle's present configuration is compatible with a particular reservation or predicted service. The location field 446 identifies a current or present location of the vehicle.

The vehicle reconfiguration table 450 includes a vehicle identifier field 452, service center identifier field 454, and a new configuration field 456. The vehicle reconfiguration table 450 tracks vehicles that have a reconfiguration pending. The vehicle identifier field 452 identifies a vehicle. The service center identifier field 454 identifies a service center scheduled or currently reconfiguring the vehicle. The new configuration field 456 indicates a configuration to which the vehicle is being adapted.

The service center table 460 includes a service center identifier field 462, and a location field 464. The service center identifier field 462 uniquely identifies a service center. The location field 464 identifies a location of the service center. Some embodiments of the MaaS platform rely on the service center table 460 to identify locations of service center(s).

The service center capabilities table 470 includes a service center identifier field 472, configuration field 474, capacity field 476, current assignments field 477, and a wait time field 478. The service center identifier field 472 uniquely identifies a particular service center. The configuration field 474 identifies a configuration that the service center is equipped to perform. In other words, the identified service center can convert a vehicle to a configuration identified by the configuration field 474. The capacity field 476 indicates a number of configurations that the service center is capable of performing over some time period (e.g. 10 configurations per day). The current assignments field 47 indicates a number of vehicles assigned to the service center for conversion to the indicated configuration. The wait time field 478 indicates how long a vehicle is likely to wait for a conversion to be completed. Note that multiple rows of the service center capabilities table 470 can indicate multiple capabilities of the service center having the indicted service center ID.

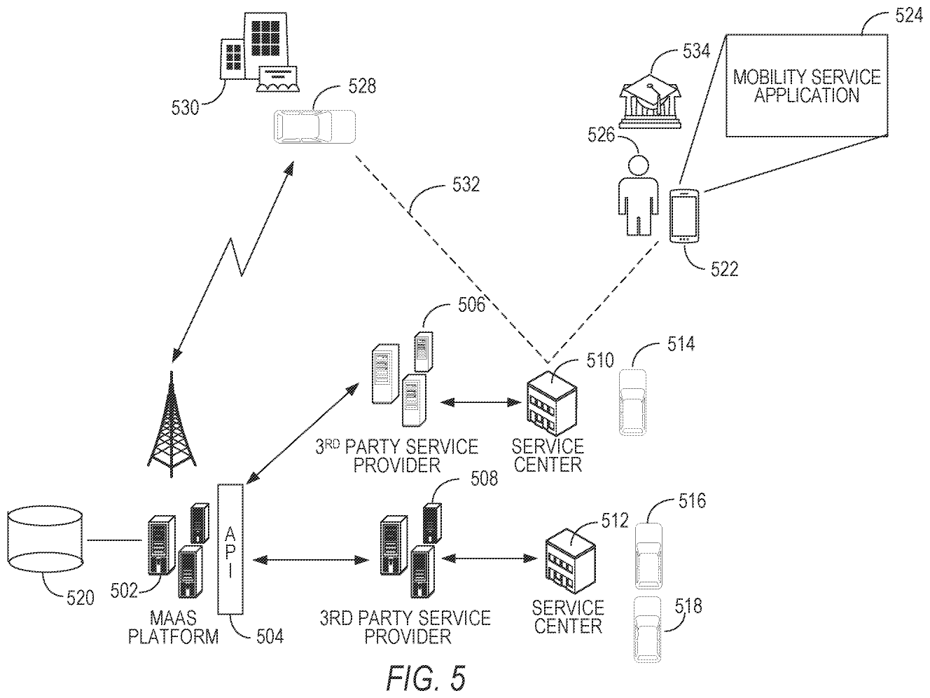

FIG. 5 is an overview diagram showing operation of a MaaS platform in one or more of the disclosed embodiments. FIG. 5 shows a MaaS platform 502. In some embodiments, the MaaS platform 502 is equivalent to the MaaS platform 206, discussed above with respect to FIG. 2.

The MaaS platform 502 provides an API 504 that enables electronic interfaces with two 3^{rd} party service providers, shown as provider 506 and provider 508. Each of the providers interfaces with its own service center, shown as service center 510 and service center 512 respectively. As shown in FIG. 5, each of service center 510 and service center 512 are in the process of reconfiguring vehicles. A service center modifies a vehicle to conform with a particular vehicle configuration. For example, the service center, in some embodiments, places preferred food and/or drink in a vehicle. In some embodiments, a service center arranging seating of the vehicle to match a particular configuration. In some embodiments, a service center installs one or more child seats in a vehicle, or attaches a rack to a vehicle. In some embodiments, a service center washes or performs maintenance on a vehicle. The service center 510 is reconfiguring a vehicle 514. Service center 510 is shown reconfiguring a vehicle 516. A second vehicle 518 is waiting to be reconfigured by the service center 512 after the vehicle 516 completes its reconfiguration.

After a service center completes any modifications necessary to convert a vehicle to a particular configuration, the service center generates, in some embodiments via the API 504, a notification to the MaaS platform 502, indicating the modification is complete. The MaaS platform 502 then instructs the vehicle, in some embodiments, to move to a location where a service will be performed using the newly configured vehicle.

FIG. 5 also shows the MaaS platform 502 interfacing with a data store 520. The MaaS platform 502 is in wireless communication with a passenger's mobile device 522. The passenger's mobile device 522 includes a mobile application that displays a mobility service user interface 524, which allows the passenger 526 to book services provided by the MaaS platform 502.

FIG. 5 also shows the MaaS platform 502 in communication with a vehicle 528. The vehicle is located at a source location 530. FIG. 5 shows that the passenger 526 has booked a service using the MaaS platform 502. The MaaS platform has assigned the vehicle 528 to the service. The service by the passenger 526 requires the vehicle 528 to be reconfigured. As such, the MaaS platform 502 generates a route 532 that indicates the vehicle 528 is to first travel to the service center 510 for reconfiguration. After reconfiguration, the vehicle is to travel to pick up the passenger 526 at a pick up location 534

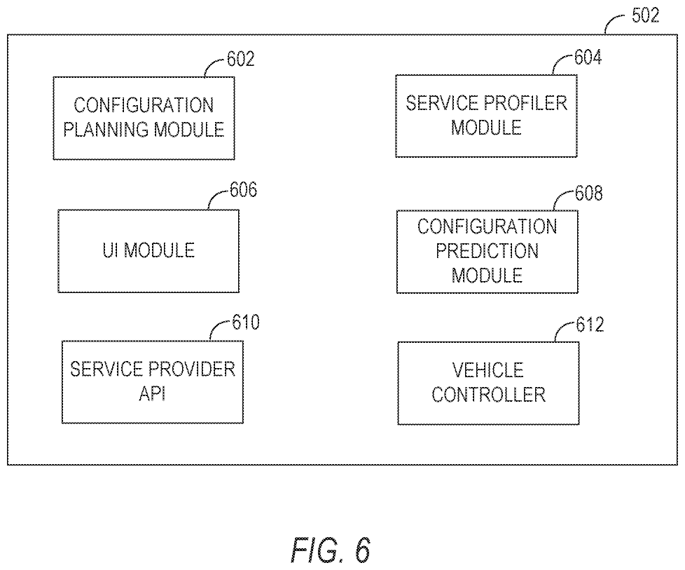

FIG. 6 is a block diagram showing an example organization of a MaaS platform. Each of the modules discussed below with respect to FIG. 6 represent, in some embodiments, groupings of instructions that configure hardware processing circuitry to perform one or more of the functions attributed to each of the modules.

Some embodiments of the MaaS platform 502 include a configuration planning module 602, service profiler module 604, UT module 606, configuration prediction module 608, a service provider application programming interface (API) 610, and a vehicle control module 612. The configuration planning module 602 determines which vehicle configuration are needed for one or more prospective time periods and schedules an appropriate number of vehicles to visit service centers as needed to affect the configurations.

The service profiler module generates service profiles or service groups based on patterns detected in user travel. For example, in some embodiments, the service profiler module 604 generates service groups defining data analogous to one or more of the fields of the service profile table 430 discussed above with respect to FIG. 4.

The UI module 606 presents one or more user interfaces to a user to facilitate use of the MaaS platform. For example, the UI module 606 displays the mobility service user interface 524 in some embodiments. In some embodiments, the UI module 606 displays an interface on a user's mobile device or smart phone (or laptop/desktop) that collects one or more indications of user profile information, such as any of the user preferences discussed above with respect to the user account table 400 of FIG. 4.

The configuration prediction module 608 predicts vehicle configurations needed during a prospective time period. As discussed in more detail below, some embodiments employ a machine learning model that predicts vehicle configurations for a prospective time period based on user preferences, historical patterns of services, and existing reservations for services.

The service provider API 610 provides an API for third party service providers. This API allows third party providers to publish services they offer to the MaaS platform, along with their capacities, availabilities, wait times, turn around times, and other information. The service provider API also allows the MaaS platform to schedule vehicle configuration changes with a particular service provider, and/or to query the service provider to obtain data on the service providers capabilities, wait times, and the like.

The vehicle control module 612 provides a command interface to vehicles, such as the vehicle 528. For human controlled vehicles, the vehicle control module 612 causes display of human readable or human interpretable instructions on an electronic display included within the vehicle. For autonomous vehicles, the vehicle control module 612 interfaces electronically with an in-vehicle control system to control the vehicle. For example, the vehicle control module 612 controls a vehicle to perform a route analogous to route 532 discussed above with respect to FIG. 5.

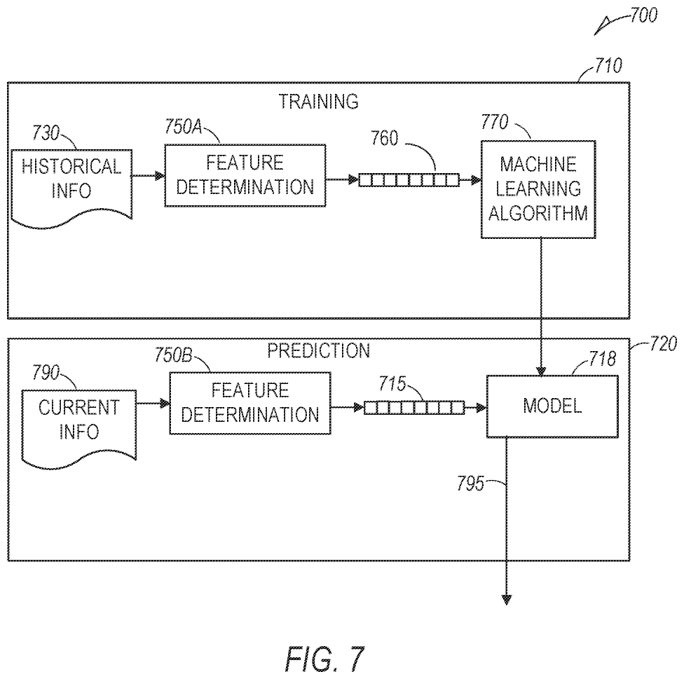

FIG. 7 shows an example machine learning module 700 according to some examples of the present disclosure. Machine learning module 700 utilizes a training module 710 and a prediction module 720. Training module 710 inputs historical information 730 into feature determination module 750A. The historical information 730 may be labeled. Example historical information may include historical service information, such as information analogous to any one or more fields of the service table 420 and/or the service profile table 430. Historical information 730 also includes, in some embodiments, user preferences, such as data analogous to one or more of the fields discussed above with respect to the user account table 400.

The historical information is stored in a training library in some embodiments. Labels included in the training library indicate a number of vehicle configurations needed to satisfy the indicated historical services and/or historical service groupings.

Feature determination module 750A determines one or more features 760 from this historical information 730. Stated generally, features 760 are a set of the information input and are determined to be predictive of a particular outcome. In some examples, the features 760 may be all the historical information 730, but in other examples, the features 760 are a subset of the historical information 730. The machine learning algorithm 770 produces a model 718 based upon the features 760 and the labels.

In the prediction module 720, current information 790 may be input to the feature determination module 750B. The current information 790 in the disclosed embodiments include similar indications of that described above with respect to the historical information 730. However, the current information 790 provides these indications for a particular user or set of users, for the purposes of predicting vehicle configurations needed during one or more prospective time periods.

Feature determination module 750B determines, in some embodiments, an equivalent set of features or a different set of features from the current information 790 as feature determination module 750A determined from historical information 730. In some examples, feature determination module 750A and 750B are the same module. Feature determination module 750B produces features 715, which is input into the model 718 to generate predictions of vehicle configurations needed during one or more prospective time periods. The training module 710 may operate in an offline manner to train the model 718. The prediction module 720, however, may be designed to operate in an online manner. It should be noted that the model 718 may be periodically updated via additional training and/or user feedback.

The prediction module 720 generates one or more outputs 795. The outputs include, in some embodiments, one or more indications of one or more vehicle configurations needed during one or more prospective time periods

The machine learning algorithm 770 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, hidden Markov models, models based on artificial life, simulated annealing, and/or virology. Examples of unsupervised learning algorithms include expectation-maximization algorithms, vector quantization, and information bottleneck method. Unsupervised models may not have a training module 710. In an example embodiment, a regression model is used and the model 718 is a vector of coefficients corresponding to a learned importance for each of the features in the vector of features 760, 715. In some embodiments, to calculate a score, a dot product of the features 715 and the vector of coefficients of the model 718 is taken.

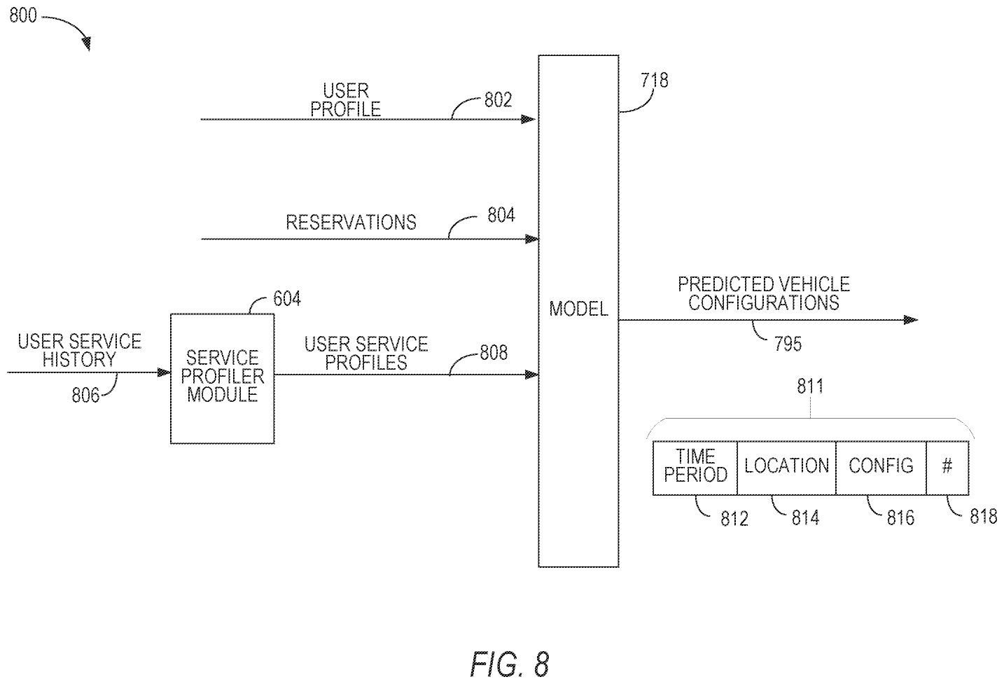

FIG. 8 shows an example data flow implemented in one or more of the disclosed embodiments. The data flow 800 shows user profile information 802 and reservation information 804 being provided to a model 718. In some embodiments, the user profile information 802 includes data analogous to one or more fields of the user account table 400, discussed above with respect to FIG. 4. In some embodiments, the reservation information 804 includes data analogous to one or more of the fields of the reservations table 410, discussed above with respect to FIG. 4.

Data flow 800 also shows a user service history 806 provided to the service profiler module 604, discussed above with respect to FIG. 6. In some embodiments, the user service history 806 includes data analogous to one or more of the fields of the service table 420, discussed above with respect to FIG. 4. The service profiler module 604 generates one or more service profiles SOS, which are also provided to the model 718. In some embodiments, the service profiles 808 include data analogous to one or more of the fields of the service profile table 430, discussed above with respect to FIG. 4.

As discussed above, the model 718 is previously trained, at least in some embodiments, based on historical information including user preferences, services history, and vehicle configurations needed to satisfy said service history w/said user preferences. By training the model 718 in this manner, the model 718 is able to predict a number of vehicle configurations needed for a given set of user preferences, reservations, a historical service profiles as discussed above. This output is depicted in FIG. 8 as output 795, which indicates predicted vehicle configurations.

Output 795 of the model 718 can vary by embodiment, but one example is shown in FIG. 8 as prediction record 811. FIG. 8 shows predicted vehicle configurations formatted so as to indicate an applicable time period 812, location 814 the vehicle is needed, the configuration needed 816, and a number 818 of those configurations needed at the indicated location. Thus, the output 795 includes, in some embodiments, multiple prediction records 811 indicating multiple different time periods, different locations, and/or different locations for those configurations.

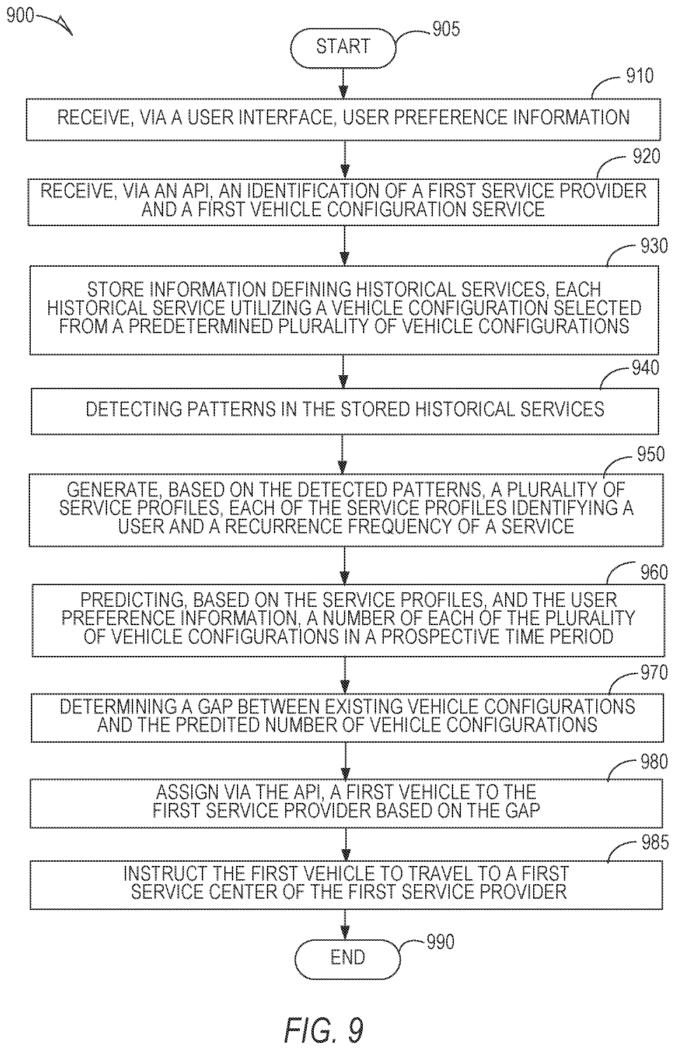

FIG. 9 is a flowchart of an example method of instructing a vehicle that is implemented in one or more of the disclosed embodiments. In some embodiments, one or more of the functions discussed below with respect to FIG. 9 and method 900 are performed by hardware processing circuitry. For example, in some embodiments, instructions (e.g. 1024 discussed below) stored in a memory (e.g. 1004 and/or 1006 discussed below) configure hardware processing circuitry (e.g. the hardware processor 1002 discussed below) to perform one or more of the functions of method 900. In some embodiments, one or more of the functions of method 900 discussed below are performed by the MaaS platform 502, discussed above with respect to FIG. 5.

After start operation 905, method 900 moves to operation 910, which receives, via a user interface, user preference information. As discussed above, in some embodiments, a user interface, such as the mobility service user interface 524 is displayed on a user device, such as a mobile device 522. (other embodiments display user interfaces on laptop computers, desktop computers, or any processing device having an interface). The user interface(s) displayed to a user allow a user to manually provide user preference information, such as any of the user preference information discussed above. Some embodiments learn user preference information based on selections of particular services by one or more users.

In operation 920, an identification of a first service provider is received. Also received in operation 920 is an identification of a first vehicle configuration service provided by the first service provider. As discussed above with respect to FIG. 5, in some embodiments, a MaaS platform (e.g. MaaS platform 502) publishes or otherwise makes available an API that enables dynamic registration of 3^{rd} party service providers with the MaaS platform. Via the API, the 3^{rd} arty service provider(s) are able to register their ability to perform certain vehicle configuration services as requested by the MaaS platform. In some embodiments, use of the API 504 allows a service provider to convey information analogous to any one or more of the fields discussed above with respect to the service center table 460, or the service center capabilities table 470. For example, in some embodiments, operation 920 includes receiving service center location information from the service provider. For example, the service center provider registers, in some embodiments, one or more service centers, capabilities of the service centers (e.g. what configurations that can provide), their typical throughput (e.g. configurations per day), and locations (e.g. coordinates or street addresses) of the service centers.

Some embodiments of operation 920 include receiving a second identification of a second service provider (e.g. via the API 504). In these embodiments, operation 920 also receives an indication of one or more types of vehicle configurations that can be provided by the second service provider (e.g. loading a vehicle with preferred drinks/food, changing seat configurations, adding a child seat, vehicle cleaning, or other configuration changes). In some embodiments, operation 920 also receives location information of one or more service centers provided by the second service provider, and which can perform the indicated configuration changes. In some cases, the types of configuration changes that the first service provider provides at least partially overlaps with types of configuration changes that the second service provider is able to accomplish, but in other cases, there is no overlap between the two service providers.

In operation 930, information defining historical services is stored in a data store. Each of the historical services utilized a particular vehicle configuration. The particular vehicle configuration is one of a predefined plurality of vehicle configurations. As discussed above, the disclosed embodiments contemplate a variety of different vehicle configurations that are necessary for the performance of corresponding variety of mobility services. These vehicle configurations include, but are not limited to, different seating configurations, different food and/or drink choices prepositioned in the vehicle, special equipment included with the vehicle (e.g., wheelchair, roof rack). As a service is performed, some embodiments record a record of said performance of said service in a datastore, such as the data store 520, discussed above with respect to FIG. 5. Some embodiments store data analogous to one or more fields of the service table 420, discussed above with respect to FIG. 4.

In operation 940, one or more patterns in the historical services are recognized or detected. For example, in some embodiments, a pattern is detected that includes a common user leaving from a common origin location and traveling to a common destination on several mobility service trips. These service trips may repeat at a common frequency, such as once per day, once per week, once per month, or some other recurring frequency. Some embodiments detect these patterns and then generate, in operation 950, one or more service profiles that describe the recurring pattern of mobility service(s). As discussed above, some embodiments generate data analogous to the service profile table 430, discussed above with respect to FIG. 4. Some embodiments detect the patterns via one or more methods, such as via neural networks, structural pattern recognition, syntactic pattern recognition, statistical pattern recognition, logical combinatorial approach to pattern recognition, an approximate reasoning approach to pattern recognition, use of support vector machines (SVMs), or other methods.

In operation 960, a number of each of the plurality of vehicle configurations are predicted for use during a prospective time period. For example, as discussed above, some embodiments employ a machine learning model (e.g. model 718) to predict a number of each vehicle configuration needed during one or more prospective time periods. As discussed above, in some embodiments, the machine learning model is trained using labeled historical data that maps historical service levels and user preferences to numbers of vehicles of each configuration needed to fulfill the requested services. By then providing the machine learning model with current information (e.g. 790), a prediction on the number of each of the configurations is provided (e.g. 795 in a format suggested by prediction record 811 in some embodiments). See also FIG. 8 above.

In some embodiments, method 900 includes receiving one or more reservations for MaaS services. For example, in some embodiments, one or more users schedule use of a MaaS service in advance, by submitting a reservation via a user interface (e.g. user interface 524). These reservations provide, in some embodiments, data analogous to one or more fields of the reservation table 420, discussed above with respect to FIG. 4. Predictions of the number of vehicle configurations needed during the prospective time period is then further based on this reservation information (e.g. information analogous to any one or more fields of the reservation table 420).

In operation 970, a gap between existing vehicle configurations and the predicted number of vehicle configurations is determined. In some embodiments a number of existing vehicles with each configuration is obtained via data analogous to the vehicle table 440, discussed above with respect to FIG. 4. The resulting aggregate number of vehicles of each configuration is compared to the predictions of vehicles needed, which, in some embodiments, is supplied by the machine learning model (e.g. model 718). Thus, for example, if ten different vehicle configurations are supported by an embodiment, the embodiment computes ten differences between an existing number of vehicles having each configuration and a predicted number of vehicles needing that configuration to accomplish predicted mobility services to be performed during the prospective time period.

In operation 980, a first vehicle is assigned to the first service provider based on the gap. For example, in some embodiments, operation 970 identifies that a number of vehicles having a first configuration is below a predicted number of vehicles of the first configuration that will be needed during the prospective time period. Operation 980 then identifies candidate vehicles that are available for conversion to the first configuration. For example, in some embodiments, the differences discussed above with respect to operation 970 identify that there are more vehicles having a second configuration than are needed during the prospective time period. Thus, some embodiments of operation 980 identify a second vehicle having the second configuration and schedule it for conversion to the first configuration before the prospective time period. Some embodiments of operation 980 consult available 3^{rd} party service providers (e.g. via data analogous to the table 460 and/or 470 to determine an appropriate service center to assign the vehicle to. For example, in some embodiments, operation 980 evaluates whether a service center is capable of making the conversion to the first configuration (e.g. via data analogous to the configuration field 474 in some embodiments), has the capacity to make the conversion (e.g. via data analogous to the capacity field 476) and has an acceptable wait time (e.g. via data analogous to the wait time field 478). An acceptable wait time is a wait time below a predefined threshold elapsed time, at least in some embodiments.

In some embodiments, a distance between the first vehicle, the first service center, and another service center are compared. In at least some situations, the disclosed embodiments select to reconfigure the first vehicle at a service center closest to the first vehicles present location. Other variables can of course affect a selection of which service center performs a vehicle configuration change. For example, wait times at each of the service centers is also examined in some embodiments, and a vehicle assigned to a service center that is not necessarily the closest service center in the event that a wait time at the closest service center meets a predefined criterion. For example, an additional travel time to travel to/from a service center that is not the closest service center is determined. If the additional travel time is lower than a difference in waiting time between the two service centers, the further distant service center is selected.

In some embodiments, a third vehicle is assigned to the second service provider based on the identified gap. For example, in some embodiments, the identified gap includes identification that more vehicles having a third configuration are predicted to be needed during the prospective time period than are currently available. To reduce or eliminate this gap, the third vehicle is assigned to the second service provider (discussed above with respect to operation 920), to accomplish a conversion of the third vehicle to the third configuration.

Note that some vehicle configurations require multiple changes or modifications to a vehicle. For example, a vehicle configuration specifies, in some embodiments, a particular beverage choice be added to the vehicle, and secondly that a particular seating configuration be used in the vehicle. In some cases, a first service provider loads vehicles with beverages and a second service provider modifies vehicle seating configurations. Thus, in these embodiments, the MaaS platform 502 coordinates travel of a vehicle to each service provider to accomplish the necessary modifications to bring a vehicle up to a target configuration. Thus, in these embodiments, the MaaS platform 502 orchestrates sending of the vehicle to a service center maintained by the first service provider to accomplish a beverage sub-configuration and to a second service center provided by a second service provider to accomplish a seating sub-configuration in order to accomplish the configuration needed as identified by the gap.

In operation 985, the first vehicle is instructed to travel to a first service center associated with the first service provider, Instructing the first vehicle includes, in some embodiments, the MaaS platform 502 sending an electronic message to the first vehicle, with the electronic message encoding the instructions to travel to the first service center. For example, the electronic message includes, in some embodiments, coordinates of the first service center location, and an instruction code indicating the first vehicle is to travel to the first location. Such a message is generated, in at least some embodiments, when an autonomous vehicle is being instructed to travel to the first service center.

In some embodiments, instructing the first vehicle to travel includes causing display on a display screen associated with the first vehicle of human readable instructions or at least human interpretable instructions to travel to the location of the first service center.

Some embodiments of method 900 include receiving a notification from the first service provider and/or second service provider when the respective vehicle configurations have been completed. In these embodiments, the completed vehicles are then assigned to perform a mobility service. For example, in some embodiments, method 900 includes receiving a request to perform a mobility service that requires the first vehicle configuration. The first vehicle is then assigned to perform the mobility service in response to receiving the notification that it has been converted to the first configuration. Similarly, a second request is received, in some embodiments, to perform a second mobility service requiring the third vehicle configuration. After receiving a notification that conversion of the third vehicle to the third vehicle configuration is complete, some embodiments of method 900 assign the third vehicle to perform the second mobility service as requested.

After operation 985 completes, method 900 moves to end operation 990.

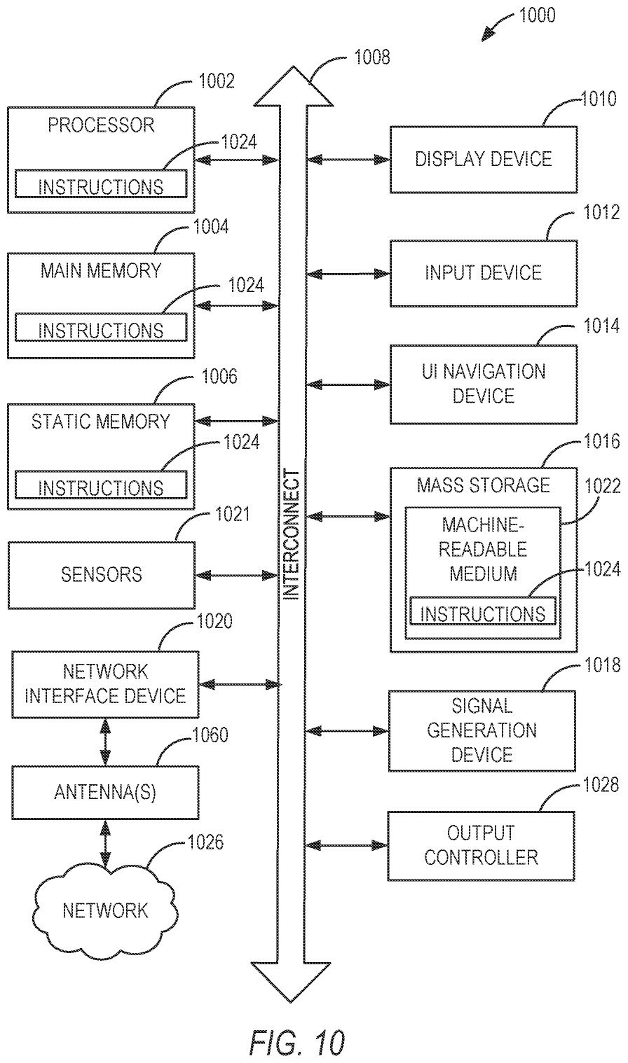

FIG. 10 illustrates a block diagram of an example machine 1000 upon which any one or more of the techniques (e.g., methodologies) discussed herein may perform. Machine (e.g., MaaS platform) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink 1008 (e.g., bus). In some embodiments, the example machine 1000 is implemented by the MaaS platform 502, discussed above with respect to FIG. 5.

Specific examples of main memory 1004 include Random Access Memory (RAM), and semiconductor memory devices, which may include, in some embodiments, storage locations in semiconductors such as registers. Specific examples of static memory 1006 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 1000 may further include a display device 1010, an input device 1012 (e.g., a keyboard), and a user interface (UI) navigation device 1014 (e.g., a mouse). In an example, the display device 1010, input device 1012 and UI navigation device 1014 may be a touch screen display. The machine 1000 may additionally include a mass storage device 1016 (e.g., drive unit), a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the hardware processor 1002 and/or instructions 1024 may comprise processing circuitry and/or transceiver circuitry.

The mass storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the mass storage device 1016 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 1022 is illustrated as a single medium, the term “machine readable medium” may include a single medium or multiple media (e.g., a centralized or distributed database, and/or associated caches and servers) configured to store the one or more instructions 1024.

An apparatus of the machine 1000 may be one or more of a hardware processor 1002 (e.g., a central processing unit (CPU), a graphics processing unit (GPU), a hardware processor core, or any combination thereof), a main memory 1004 and a static memory 1006, sensors 1021, network interface device 1020, antennas 1060, a display device 1010, an input device 1012, a UI navigation device 1014, a mass storage device 1016, instructions 1024, a signal generation device 1018, and an output controller 1028. The apparatus may be configured to perform one or more of the methods and/or operations disclosed herein. The apparatus may be intended as a component of the machine 1000 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1020 may include one or more physical jacks (e.g., Ethernet, coaxial, or phone jacks) or one or more antennas to connect to the communications network 1026. In an example, the network interface device 1020 may include one or more antennas 1060 to wirelessly communicate using at least one of single-input multiple-output (SIMO), multiple-input multiple-output (AMMO), or multiple-input single-output (MISO) techniques. In some examples, the network interface device 1020 may wirelessly communicate using Multiple User MIMO techniques. The term “transmission medium” shall be taken to include any intangible medium that is capable of storing, encoding or carrying instructions for execution by the machine 1000, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more MaaS platforms (e.g., a standalone, client or server MaaS platform) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more MaaS platforms (e.g., a standalone, client or server MaaS platform) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Example 1 is a system, comprising: hardware processing circuitry; and one or more hardware memories storing instructions that when executed configure the hardware processing circuitry to perform operations comprising: receiving a user service profile comprising user service history; generating a plurality of user service profiles from the user service profile, wherein the plurality of user service profiles comprise historical service records for a plurality of users; detecting patterns in historical service records associated with a plurality of users, each of the historical service records including a particular vehicle configuration for a particular user service profile; generating a model based on the detected patterns; and predicting, based on the model, a number of each of a plurality of vehicle configurations in a prospective time period.

In Example 2, the subject matter of Example 1 optionally includes the operations further comprising: determining a gap between existing vehicle configurations and the predicted number of vehicle configurations; and instructing, based on the gap, a vehicle to travel to a service center for reconfiguration.

In Example 3, the subject matter of Example 2 optionally includes the operations further comprising receiving, via an application programming interface (API), an identification of a first service provider and a first vehicle configuration service provided by the first service provider.

In Example 4, the subject matter of Example 3 optionally includes the operations further comprising receiving, via the application programming interface (API), an identification of a location of the service center of the first service provider, wherein the instructing is based on the identification.

In Example 5, the subject matter of any one or more of Examples 1-4 optionally include the operations further comprising receiving a plurality of reservations for mobility services during the prospective time period, wherein the predicting is based on the plurality of reservations.

In Example 6, the subject matter of any one or more of Examples 1-5 optionally include wherein the predicting is further based on user preference information, the user preference information indicating one or more of a food or drink preference of the user, a seating preference of the user, a vehicle preference of the user, or a luggage preference of the user.

In Example 7, the subject matter of any one or more of Examples 3-6 optionally include wherein the first vehicle configuration service modifies a vehicle to have a first configuration, and wherein the determining of the gap comprises determining a difference between a number of vehicles having the first configuration, and a number of vehicles predicted to use the first configuration in the prospective time period, and wherein the instructing of the vehicle is based on the difference.

In Example 8, the subject matter of Example 7 optionally includes the Operations further comprising: receiving, via the application programming interface (API), an identification of a second service provider and a second vehicle configuration service provided by the second service provider, wherein the second vehicle configuration service modifies a vehicle to have a second configuration, and wherein the determining of the gap comprises determining a second difference between a number of vehicles having the second configuration, and a number of vehicles predicted to use the second configuration in the prospective time period; and assigning a second vehicle to the second service provider based on the second difference.

In Example 9, the subject matter of Example 8 optionally includes the operations further comprising determining, via the API; a waiting time associated with the second vehicle configuration service, wherein the assigning of the second vehicle to the second service provider is based on the waiting time.

In Example 10, the subject matter of Example 9 optionally includes the operations further comprising: determining, via the API, a first location of a first service center of the first service provider; determining, via the API, a second location of a second service center of the second service provider; determining a first distance between a location of the vehicle and the first service center; determining a second distance between the location of the vehicle and the second service center; and comparing the first distance to the second distance, wherein the assigning of the vehicle to the first service provider is based on the comparing.

In Example 11, the subject matter of any one or more of Examples 3-10 optionally include the operations further comprising: receiving, via the API, a notification that the first vehicle configuration service of the vehicle is complete; receiving, from a user, a request for a service requiring the first configuration; and instructing the vehicle to travel to the service center based on the notification and the request.

Example 12 is at least one computer readable storage medium comprising instructions that when executed configure hardware processing circuitry to perform operations, comprising: receiving a user service profile comprising user service history; generating a plurality of user service profiles from the user service profile, wherein the plurality of user service profiles comprise historical service records for a plurality of users; detecting patterns in historical service records associated with a plurality of users, each of the historical service records including a particular vehicle configuration for a particular user service profile; generating a model based on the detected patterns; and predicting, based on the model, a number of each of a plurality of vehicle configurations in a prospective time period.

In Example 13, the subject matter of Example 12 optionally includes the operations further comprising: determining a gap between existing vehicle configurations and the predicted number of vehicle configurations; and instructing, based on the gap, a vehicle to travel to a service center for reconfiguration.

In Example 14, the subject matter of Example 13 optionally includes the operations further comprising receiving, via an application programming interface (API), an identification of a first service provider and a first vehicle configuration service provided by the first service provider.

In Example 15, the subject matter of Example 14 optionally includes the operations further comprising receiving, via the application programming interface (API), an identification of a location of the service center of the first service provider, wherein the instructing is based on the identification.

In Example 16, the subject matter of any one or more of Examples 12-15 optionally include the operations further comprising receiving a plurality of reservations for mobility services during the prospective time period, wherein the predicting is based on the plurality of reservations.

In Example 17, the subject matter of any one or more of Examples 12-16 optionally include wherein the predicting is further based on user preference information, the user preference information indicating one or more of a food or drink preference of the user, a seating preference of the user, a vehicle preference of the user, or a luggage preference of the user.

In Example 18, the subject matter of any one or more of Examples 14-17 optionally include wherein the first vehicle configuration service modifies a vehicle to have a first configuration, and wherein the determining of the gap comprises determining a difference between a number of vehicles having the first configuration, and a number of vehicles predicted to use the first configuration in the prospective time period, and wherein the instructing of the vehicle is based on the difference.

In Example 19, the subject matter of Example 18 optionally includes the operations further comprising: receiving, via the application programming interface (AN), an identification of a second service provider and a second vehicle configuration service provided by the second service provider, wherein the second vehicle configuration service modifies a vehicle to have a second configuration, and wherein the determining of the gap comprises determining a second difference between a number of vehicles having the second configuration, and a number of vehicles predicted to use the second configuration in the prospective time period; and assigning a second vehicle to the second service provider based on the second difference.

In Example 20, the subject matter of Example 19 optionally includes the operations further comprising determining, via the API, a waiting time associated with the second vehicle configuration service, wherein the assigning of the second vehicle to the second service provider is based on the waiting time.

In Example 21, the subject matter of Example 20 optionally includes the operations further comprising: determining, via the API, a first location of a first service center of the first service provider; determining, via the API, a second location of a second service center of the second service provider; determining a first distance between a location of the vehicle and the first service center; determining a second distance between the location of the vehicle and the second service center; and comparing the first distance to the second distance, wherein the assigning of the vehicle to the first service provider is based on the comparing.

In Example 22, the subject matter of any one or more of Examples 14-21 optionally include the operations further comprising: receiving, via the API, a notification that the first vehicle configuration service of the vehicle is complete; receiving, from a user, a request for a service requiring the first configuration; and instructing the vehicle to travel to the service center based on the notification and the request.

Example 23 is a method performed by hardware processing circuitry, comprising: receiving a user service profile comprising user service history; generating a plurality of user service profiles from the user service profile, wherein the plurality of user service profiles comprise historical service records for a plurality of users; detecting patterns in historical service records associated with a plurality of users, each of the historical service records including a particular vehicle configuration for a particular user service profile; generating a model based on the detected patterns; and predicting, based on the model, a number of each of a plurality of vehicle configurations in a prospective time period.

In Example 24, the subject matter of Example 23 optionally includes determining a gap between existing vehicle configurations and the predicted number of vehicle configurations; and instructing, based on the gap, a vehicle to travel to a service center for reconfiguration.

In Example 25, the subject matter of Example 24 optionally includes receiving, via an application programming interface (API), an identification of a first service provider and a first vehicle configuration service provided by the first service provider.

In Example 26, the subject matter of Example 25 optionally includes receiving, via the application programming interface (API), an identification of a location of the service center of the first service provider; wherein the instructing is based on the identification.

In Example 27, the subject matter of any one or more of Examples 23-26 optionally include receiving a plurality of reservations for mobility services during the prospective time period, wherein the predicting is based on the plurality of reservations.

In Example 28, the subject matter of any one or more of Examples 23-27 optionally include wherein the predicting is further based on user preference information, the user preference information indicating one or more of a food or drink preference of the user, a seating preference of the user, a vehicle preference of the user, or a luggage preference of the user.

In Example 29, the subject matter of any one or more of Examples 25-28 optionally include wherein the first vehicle configuration service modifies a vehicle to have a first configuration, and wherein the determining of the gap comprises determining a difference between a number of vehicles having the first configuration, and a number of vehicles predicted to use the first configuration in the prospective time period, and wherein the instructing of the vehicle is based on the difference.

In Example 30, the subject matter of Example 29 optionally includes receiving, via the application programming interface (API), an identification of a second service provider and a second vehicle configuration service provided by the second service provider, wherein the second vehicle configuration service modifies a vehicle to have a second configuration, and wherein the determining of the gap comprises determining a second difference between a number of vehicles having the second configuration, and a number of vehicles predicted to use the second configuration in the prospective time period; and assigning a second vehicle to the second service provider based on the second difference.

In Example 31, the subject matter of Example 30 optionally includes determining, via the API, a waiting time associated with the second vehicle configuration service, wherein the assigning of the second vehicle to the second service provider is based on the waiting time.

In Example 32, the subject matter of Example 31 optionally includes determining, via the API, a first location of a first service center of the first service provider; determining, via the API, a second location of a second service center of the second service provider; determining a first distance between a location of the vehicle and the first service center; determining a second distance between the location of the vehicle and the second service center; and comparing the first distance to the second distance, wherein the assigning of the vehicle to the first service provider is based on the comparing.

In Example 33, the subject matter of any one or more of Examples 25-32 optionally include receiving, via the API, a notification that the first vehicle configuration service of the vehicle is complete; receiving, from a user, a request for a service requiring the first configuration; and instructing the vehicle to travel to the service center based on the notification and the request.

Example 34 is an apparatus, comprising: means for receiving a user service profile comprising user service history; means for generating a plurality of user service profiles from the user service profile, wherein the plurality of user service profiles comprise historical service records for a plurality of users; means for detecting patterns in historical service records associated with a plurality of users, each of the historical service records including a particular vehicle configuration for a particular user service profile; means for generating a model based on the detected patterns; and means for predicting, based on the model, a number of each of a plurality of vehicle configurations in a prospective time period.

In Example 35, the subject matter of Example 34 optionally includes means for determining a gap between existing vehicle configurations and the predicted number of vehicle configurations; and means for instructing, based on the gap, a vehicle to travel to a service center for reconfiguration.

In Example 36, the subject matter of Example 35 optionally includes means for receiving, via an application programming interface (API), an identification of a first service provider and a first vehicle configuration service provided by the first service provider.

In Example 37, the subject matter of Example 36 optionally includes means for receiving, via the application programming interface (API), an identification of a location of the service center of the first service provider, wherein the means for instructing is configured to instruct based on the identification.

In Example 38, the subject matter of any one or more of Examples 34-37 optionally include means for receiving a plurality of reservations for mobility services during the prospective time period, wherein the means for predicting is configured to further base the prediction on the plurality of reservations.

In Example 39, the subject matter of any one or more of Examples 34-38 optionally include wherein the means for predicting is configured to base the prediction on user preference information, the user preference information indicating one or more of a food or drink preference of the user, a seating preference of the user, a vehicle preference of the user, or a luggage preference of the user.

In Example 40, the subject matter of any one or more of Examples 36-39 optionally include wherein the first vehicle configuration service modifies a vehicle to have a first configuration, and wherein the means for determining the gap is configured to determine a difference between a number of vehicles having the first configuration, and a number of vehicles predicted to use the first configuration in the prospective time period, and wherein the instructing of the vehicle is based on the difference.

In Example 41, the subject matter of Example 40 optionally includes means for receiving, via the application programming interface (API), an identification of a second service provider and a second vehicle configuration service provided by the second service provider, wherein the second vehicle configuration service modifies a vehicle to have a second configuration, and wherein the means for determining the gap is configured to determine a second difference between a number of vehicles having the second configuration, and a number of vehicles predicted to use the second configuration in the prospective time period; and means for assigning a second vehicle to the second service provider based on the second difference.

In Example 42, the subject matter of Example 41 optionally includes means for determining, via the API, a waiting time associated with the second vehicle configuration service, wherein the assigning of the second vehicle to the second service provider is based on the waiting time.

In Example 43, the subject matter of Example 42 optionally includes means for determining, via the API, a first location of a first service center of the first service provider; means for determining, via the API, a second location of a second service center of the second service provider; means for determining a first distance between a location of the vehicle and the first service center; means for determining a second distance between the location of the vehicle and the second service center; and means for comparing the first distance to the second distance, wherein the assigning of the vehicle to the first service provider is based on the comparing.

In Example 44, the subject matter of any one or more of Examples 36-43 optionally include means for receiving, via the API, a notification that the first vehicle configuration service of the vehicle is complete; means for receiving, from a user, a request for a service requiring the first configuration; and means for instructing the vehicle to travel to the service center based on the notification and the request.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

1. A system, comprising:
hardware processing circuitry; and
one or more hardware memories storing instructions that when executed configure the hardware processing circuitry to perform operations comprising:
receiving a user service profile comprising user service history;
generating a plurality of user service profiles from the user service profile, wherein the plurality of user service profiles comprise historical service records for a plurality of users;
detecting patterns in historical service records associated with a plurality of users, each of the historical service records including a particular vehicle configuration for a particular user service profile;
generating a model based on the detected patterns; and
predicting, based on the model, a number of each of a plurality of vehicle configurations in a prospective time period.

2. The system of claim 1, the operations further comprising:
determining a gap between existing vehicle configurations and the predicted number of vehicle configurations; and
instructing, based on the gap, a vehicle to travel to a service center for reconfiguration.

3. The system of claim 2, the operations further comprising receiving, via an application programming interface (API), an identification of a first service provider and a first vehicle configuration service provided by the first service provider.

4. The system of claim 3, the operations further comprising receiving, via the application programming interface (API), an identification of a location of the service center of the first service provider, wherein the instructing is based on the identification.

5. The system of claim 1, the operations further comprising receiving a plurality of reservations for mobility services during the prospective time period, wherein the predicting is based on the plurality of reservations.

6. The system of claim 1, wherein the predicting is further based on user preference information, the user preference information indicating one or more of a food or drink preference of the user, a seating preference of the user, a vehicle preference of the user, or a luggage preference of the user.

7. The system of claim 3, wherein the first vehicle configuration service modifies a vehicle to have a first configuration, and wherein the determining of the gap comprises determining a difference between a number of vehicles having the first configuration, and a number of vehicles predicted to use the first configuration in the prospective time period, and wherein the instructing of the vehicle is based on the difference.

8. The system of claim 7, the operations further comprising:
receiving, via the application programming interface (API), an identification of a second service provider and a second vehicle configuration service provided by the second service provider, wherein the second vehicle configuration service modifies a vehicle to have a second configuration, and wherein the determining of the gap comprises determining a second difference between a number of vehicles having the second configuration, and a number of vehicles predicted to use the second configuration in the prospective time period; and
assigning a second vehicle to the second service provider based on the second difference.

9. The system of claim 8, the operations further comprising determining, via the API, a waiting time associated with the second vehicle configuration service, wherein the assigning of the second vehicle to the second service provider is based on the waiting time.

10. The system of claim 9, the operations further comprising:
determining, via the APT, a first location of a first service center of the first service provider;
determining, via the API, a second location of a second service center of the second service provider;
determining a first distance between a location of the vehicle and the first service center;
determining a second distance between the location of the vehicle and the second service center; and
comparing the first distance to the second distance, wherein the assigning of the vehicle to the first service provider is based on the comparing.

11. The system of claim 4, the operations further comprising:
receiving, via the API, a notification that the first vehicle configuration service of the vehicle is complete;
receiving, from a user, a request for a service requiring the first configuration; and
instructing the vehicle to travel to the service center based on the notification and the request.

12. At least one computer readable storage medium comprising instructions that when executed configure hardware processing circuitry to perform operations, comprising:
receiving a user service profile comprising user service history;
generating a plurality of user service profiles from the user service profile, wherein the plurality of user service profiles comprise historical service records for a plurality of users;
detecting patterns in historical service records associated with a plurality of users, each of the historical service records including a particular vehicle configuration for a particular user service profile;
generating a model based on the detected patterns; and
predicting, based on the model, a number of each of a plurality of vehicle configurations in a prospective time period.

13. The at least one computer readable storage medium of claim 12, the operations further comprising:
determining a gap between existing vehicle configurations and the predicted number of vehicle configurations; and
instructing, based on the gap, a vehicle to travel to a service center for reconfiguration.

14. The at least one computer readable storage medium of claim 13, the operations further comprising receiving, via an application programming interface (API), an identification of a first service provider and a first vehicle configuration service provided by the first service provider.

15. The at least one computer readable storage medium of claim 14, the operations further comprising receiving, via the application programming interface (API), an identification of a location of the service center of the first service provider, wherein the instructing is based on the identification.

16. The at least one computer readable storage medium of claim 12, the operations further comprising receiving a plurality of reservations for mobility services during the prospective time period, wherein the predicting is based on the plurality of reservations.

17. The at least one computer readable storage medium of claim 12, wherein the predicting is further based on user preference information, the user preference information indicating one or more of a food or drink preference of the user, a seating preference of the user, a vehicle preference of the user, or a luggage preference of the user.

18. An apparatus, comprising:
means for receiving a user service profile comprising user service history;
means for generating a plurality of user service profiles from the user service profile, wherein the plurality of user service profiles comprise historical service records for a plurality of users;
means for detecting patterns in historical service records associated with a plurality of users, each of the historical service records including a particular vehicle configuration for a particular user service profile;
means for generating a model based on the detected patterns; and
means for predicting, based on the model, a number of each of a plurality of vehicle configurations in a prospective time period.

19. The apparatus of claim 18, further comprising:
means for determining a gap between existing vehicle configurations and the predicted number of vehicle configurations; and
means for instructing, based on the gap, a vehicle to travel to a service center for reconfiguration.

20. The apparatus of claim 19, further comprising means for receiving, via an application programming interface (API), an identification of a first service provider and a first vehicle configuration service provided by the first service provider.

21. The apparatus of claim 20, further comprising means for receiving, via the application programming interface (API), an identification of a location of the service center of the first service provider, wherein the means for instructing is configured to instruct based on the identification.
